(19) United States
(12) Patent Application Publication
(10) Pub. No.: US 2012/0313758 A1
(43) Pub. Date: Dec. 13, 2012

(54) METHODS AND APPARATUSES FOR ACTIVATING AND POWERING RADIO FREQUENCY IDENTIFICATION TAGS AND LABELS

(76) Inventors: Chris Savarese, Danville, CA (US); Noel H. C. Marshall, Gerringong (AU); Susan McGill, Redwood City, CA (US)

(21) Appl. No.: 11/869,714

(22) Filed: Oct. 9, 2007

Related U.S. Application Data
(60) Provisional application No. 60/850,993, filed on Oct. 10, 2006.
(60) Provisional application No. 60/876,714, filed on Dec. 21, 2006.

(51) Int. Cl. G06K 7/01; G06K 19/073

(52) U.S. Cl. 340/10.1; 235/492

(57) ABSTRACT

Methods and apparatuses for activating and powering RFID labels and tags are described herein. A label is activated from an “off” mode in response to receiving an activating signal. The label may include an integrated circuit and one or more powering devices coupled to the IC. The one or more powering devices may include a rechargeable battery, a solar power device, a non-rechargeable battery, or any combination thereof In one embodiment, a power from at least one of the one or more powering devices is provided to the integrated circuit in response to receiving of the activating signal.

This application claims the benefit of the filing dates of U.S. Provisional Applications 60/850,993, filed on Oct. 10, 2006, and 60/876,714, filed on Dec. 21, 2006, and both of these applications are incorporated herein by reference.

### FIELD OF THE INVENTION

An embodiment relates generally to the field of Radio Frequency Identification (RFID). More particularly, an embodiment relates to a method and a system for activating and powering RFID tags and labels.

### BACKGROUND OF THE INVENTION

RFID is a type of automatic identification system for tracking and identifying an item. A RFID system consists of a RFID reader, a RFID tag attached to or embedded into the item to be tracked and optionally a host computer. The RFID reader is a device consisting of an antenna packaged with a transceiver and a decoder. Similarly, the RFID tag includes an integrated circuit combined with an antenna. The RFID reader tracks the RFID tags by emitting radio frequency waves and thereby activating the RFID tag which is within range of the RFID reader. The RFID tag responds by sending data back to the RFID reader which optionally transfers the data to the host computer for further processing.

In general, the RFID tag may be classified as passive, active or semi-active. A passive tag is a RFID tag that does not contain a battery. The power is supplied by the RFID reader. When radio waves from the RFID reader are encountered by a passive RFID tag, the antenna within the RFID tag interacts with an electromagnetic field. The RFID tag draws power from the field to operate the circuits in the RFID tag. As the RFID tag functions without a battery, the lifetime of the tag can be long. Such RFID tags are also less expensive to manufacture and smaller in size. However, the RFID tags can be read only at very short distance and is hence, limited in its applications. In addition, it may not be possible to include sensors that require electricity for power.

An active RFID tag is equipped with a battery that can be used as a partial or complete source of power for the RFID tag's circuitry and antenna. The battery may be replaceable or non-replaceable. An active RFID tag can be read at a longer distance, hence, greatly improving the utility of the device. In addition, the RFID tag may be equipped with other sensors that require electricity. However, the usage of such RFID tag is limited by the lifetime, cost and weight of the battery.

A semi-active RFID tag uses a hybrid of energy from the radio waves of RFID reader and battery. In general, battery power is used for operating local circuitry while power from the radio waves of RFID reader is used for communicating with the RFID reader. Like the active RFID tag, the semi-active RFID tag is limited by the lifetime of the battery.

An active RFID tag and a portable RFID reader may be used to locate an object which includes the active RFID tag. An example of such a system is the Loc8tor system; see www.loc8tor.com. The Loc8tor handheld can find an active RFID tag from a distance of up to 600 feet. The Loc8tor handheld provides a user interface which shows the distance (and direction) of the RFID tag relative to the Loc8tor handheld. The RFID tag in the case of the Loc8tor system is also limited by the battery life of the tag's battery.

### SUMMARY OF THE DESCRIPTION

According to one aspect of the invention, there is provided a label for attaching to an object to be located, the label including at least one integrated circuit (IC) containing information relating to the object, an antenna coupled to the IC for communicating the information relating to the object with an object locating device, such as a portable RFID reader, and one or more powering devices to provide electrical energy to the integrated circuit, wherein the integrated circuit is capable of selecting at least one of the one or more powering devices, wherein the one or more powering devices include a rechargeable battery and a solar power device which recharges the rechargeable battery. The label may be less than about 2.0 mm in thickness, and the rechargeable battery may be a printed rechargeable battery, and the information in the IC may be programmable through a programming operation in the object locating device. In an alternative embodiment, the IC may contain information which is fixed and not programmable (e.g. a fixed 32 or 64 bit code) and the object locating device is programmable to associate a name (e.g. Chris's 9 iron golf club) with a particular code in the information in an IC so that the IC (and the object it is attached to) can be located by selecting the name, associated with that IC, on the object locating device.

The IC in the label may include RFID circuitry and power regulating circuitry and recharging circuitry; the power regulating circuitry and recharging circuitry may control charging of the rechargeable battery by the solar power device. The power regulating circuitry may also control modes of power consumption, for example, “sleep”, “on” and “off” modes. The object locating device may be a portable RFID reader which transmits only one identifier at a time in order to locate only one object having the identifier. The plurality of powering devices may further include a non-rechargeable battery coupled to the IC; the non-rechargeable battery in this case may provide power to the IC while the solar power device recharges the rechargeable battery.

In one embodiment, a method to activate a label (e.g., RFID tag) from an “off” mode in response to receiving an activating signal is disclosed. The activating signal may be, for example, a radio frequency (RF) signal, light, and the like. The label may include an integrated circuit and one or more powering devices coupled to the IC. The one or more powering devices may include, for example, a rechargeable battery, a solar power device, a non-rechargeable battery, or any combination thereof. In one embodiment, a power from at least one of the one or more powering devices is provided to the integrated circuit in response to receiving of the activating signal. In one embodiment, the activating of the label from the “off” mode includes placing the integrated circuit into a “low power” mode, e.g., a “sleep” mode.

In one embodiment, the label (e.g., a RFID tag) is disclosed that includes an integrated circuit (IC) containing an information relating to an object, an antenna coupled to the IC to receive a radio frequency (RF) signal, and one or more powering devices coupled to provide power to activate the integrated circuit from the “off” mode. In one embodiment, the IC may comprise a power activating device that acts in response to receiving an activating signal, e.g., a radio frequency signal, to activate a microprocessor, and a power regulating and recharging circuitry coupled to the microprocessor. The microprocessor is configured to control a power regulating and recharging circuitry that operates to provide power to IC. In another embodiment, the IC comprises a microprocessor coupled to one or more powering devices. The microprocessor is configured to be directly activated in response to receiving an activating signal, e.g., light, by a powering device, e.g., a solar power device. The microprocessor is further configured to control a power regulating and recharging circuitry that operates to provide power to the IC.

In one embodiment, a label is in an “off” state until activated by a device, for example, an object locating device. In one embodiment, a user can turn the label “on” by activating the label with the device, for example, a handheld device. In one embodiment, the activation may be accomplished by sending a radio frequency signal to the label. Next, an antenna on the label receives the signal from the device. The received signal provides energy to activate the label. In one embodiment, once activated, the label may perform a registration operation with the device, e.g., the label may exchange its unique code with the device. This “registration” of the label may provide the device with a unique identifier for the label. In one embodiment, a user can select a label to search from a list of stored unique identifiers in the device. In one embodiment, when the user selects a unique identifier the device transmits a signal with the code.

In one embodiment, the label transmits a response, which indicates a match, if transmitted data from the object locating device represents the information stored in the IC; a match response from the IC causes the object locating device to present a user interface, such as an audio sound and/or a displayed graphic which represents a received signal strength indication (RSSI), which indicates a location of the label (containing the IC) relative to the object locating device. The user interface may include an indication of range or distance to the object and an indication of the direction (e.g. in azimuth) of the object. If the transmitted data from the object locating device does not represent the information stored in the IC, then the IC does not transmit a response indicating a match.

In an alternative embodiment, a RFID tag can turn itself “on” from an “off” state when exposed to light. A device, for example, a RFID reader, may be used as a reader that can recognize all RFID tags. A portion of the embedded code associated with the RFID tags may include a generic code. The device, for example a “master” reader, can recognize the generic code and locate all tags.

In one embodiment, several unique labels, each storing a unique (or quasi-unique) code, are applied to a set of golf clubs of a user. The user may either carry the object locating device (e.g. in the user's pocket) or attach the device on a golf cart or golf bag. The object locating device may be used to alert the user if a golf club is lost by presenting an alert (e.g. an alarm sound) if the golf club is beyond a predetermined distance (as measured, for example, by RSSI) or if the golf club is missing (e.g. not within a predetermined distance) for a predetermined period of time. The object locating device may repeatedly transmit a series of codes one at a time, each code corresponding to one of the IC's on one of the golf clubs in the set of golf clubs. If an RSSI for one of the codes is too low, then the object locating device issues an alert.

In another embodiment, a device, for example, the object locating device, and/or a RFID reader that is configued to transmit activation signal to a RFID label and/or a RFID tag, is incorporated into a personal device, for example, a mobile phone.

In one embodiment, a RFID label and/or RFID tag is configured to be attached to a golf club, a radio controlled device, e.g., a model radio controller car, a plane, a model rocket, hunting device, e.g., an arrow, and other objects that may need to be located. In yet another embodiment, a RFID label and/or RFID tag may be configured to be installed on a windshield of an automobile.

Other features of the invention will be apparent from the accompanying drawings and from the detailed description that follows.

### BRIEF DESCRIPTION OF THE DRAWINGS

An embodiment of the present invention is illustrated by way of example and not limited in the figures of the accompanying drawings in which like references indicate similar elements and in which:

FIG. 1 is a diagram illustrating a RFID system 1, in accordance with one embodiment of the present invention;

FIG. 2 is an exploded view illustrating various components of the RFID tag 2 in accordance with one exemplary embodiment of the invention;

FIG. 3 is a block diagram illustrating one example of a manner in which the integrated circuit 6A is connected to the various components of the RFID tag 2;

FIG. 4 shows one embodiment of a block diagram of a label that is configured to be activated and powered from an “off” mode using one or more RF pulses; and

FIG. 5 shows another embodiment of a block diagram of a label that is activated and powered from an “off” mode using light.

FIG. 6 is a graph which shows one embodiment of operating a label in different modes.

FIG. 7 is a graph which shows another embodiment of operating a label in different modes.

### DETAILED DESCRIPTION

The subject invention will be described with references to numerous details set forth below, and the accompanying drawings will illustrate the invention. The following description and drawings are illustrative of the invention and are not to be construed as limiting the invention. Numerous specific details are described to provide a thorough understanding of the present invention. However, in certain instances, well known or conventional details are not described in order to not unnecessarily obscure the present invention in detail. It will be evident, however, to one skilled in the art that the present invention may be practiced without these specific details.

Reference throughout the specification to “one embodiment,” “another embodiment,” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

The present invention presents, in one embodiment, a method and a system for providing electrical energy to a RFID tag with an efficient and renewable energy source, such as solar energy, according to one exemplary embodiment.

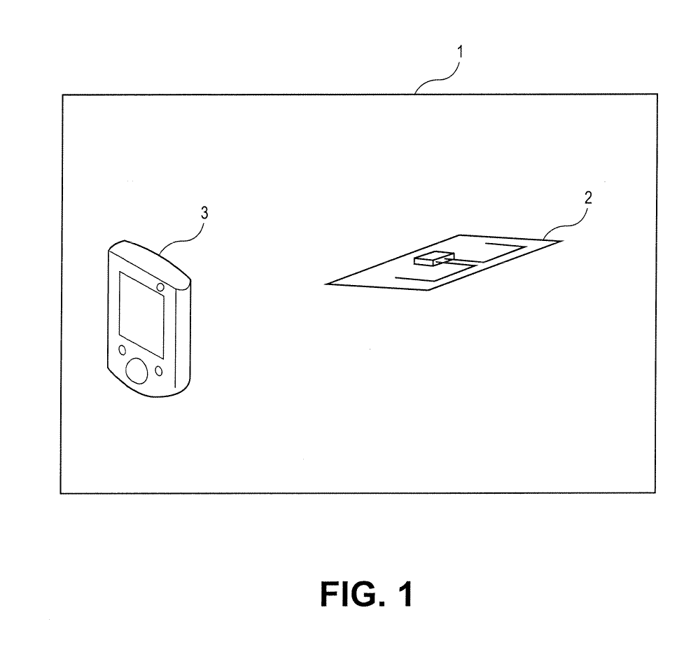

FIG. 1 illustrates a RFID system 1 comprising a RFID reader 3 and a RFID tag 2, which may be in the form of a label in accordance with one embodiment of the present invention. The RFID reader 3 is a device that interrogates the RFID tag 2 which may be attached to or embedded into an item. The RFID reader 3 has an antenna that emits encoded radio frequency waves which interrogate the RFID tag 2. If the tag contains a matching code, the RFID tag 2 responds by sending data back to the RFID reader 3. The data may include information about the item, such as the unique code number or Electronic Product Code (EPC), transaction record and characteristics of the item.

One common problem of a prior RFID system relates to reader collision and tag collision. Reader collision occurs when the coverage area of one RFID reader overlaps with that of another RFID reader. Reader collision leads to signal interference and multiple reads of the same tag. On the other hand, tag collision occurs when more than one RFID tag reflects back a signal at the same time, thereby confusing the RFID reader.

In one exemplary embodiment, the present invention avoids tag collision by associating a unique code with each RFID tag 2 and by attempting to read only one tag at a time by transmitting a unique code for a given tag at a time. Separate time slots are reserved for each code and hence each tag. Therefore, the RFID tag 2 will only be activated when it hears its own unique code from the RFID reader. Although the RFID reader 3 communicates with one RFID tag 2 at any one time, it is well known that each communication process takes only milliseconds and appears that all the RFID tags 2 are being read nearly simultaneously.

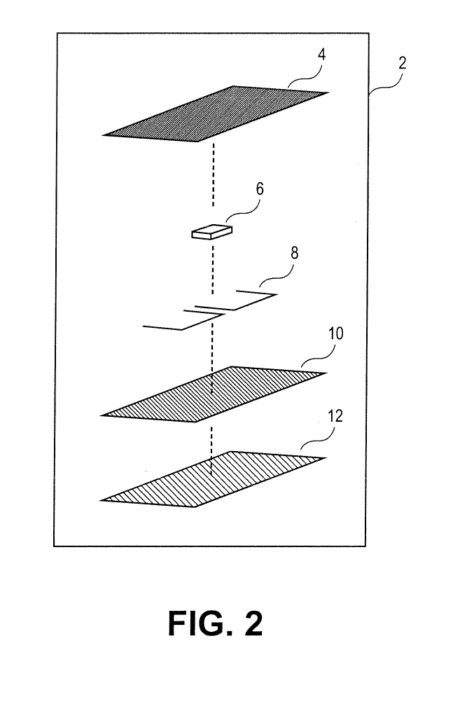

In another embodiment, the RFID tag can operate in a plurality of modes of power consumption, e.g., “sleep”, “on” and “off” modes. For example the RFID tag may turn itself on from an “off “state in response to an activation signal, as described in further detail below. Referring to FIG. 2, various components of the RFID tag 2 are further illustrated, according to one exemplary embodiment of the invention. In this example, the RFID tag 2 comprises a first powering device 4, an integrated circuit 6, an antenna 8, a second powering device 10 and a third powering device 12. As illustrated in FIG. 2, the components (4, 8, 10 and 12) are printed or otherwise fabricated in separate thin films or circuit boards which are adhered together. However, the components (4, 8, 10 and 12) may also be combined and printed on a single thin film.

It will also be noted that in at least one embodiment of the present invention, the RFID tag 2 is designed to comprise three energy sources (4, 10 and 12). The first powering device 4 may include a solar cell layer which converts solar energy into a usable amount of electrical power such as direct current electricity. In one embodiment, the first powering device 4 is configured to charge the second powering device 10 which is a rechargeable battery. An example of such low profile (or “thin film”) rechargeable energy cell may be solid state Lithium and Lithium-ion battery technology developed by Oak Ridge National Laboratory, located in Oak Ridge, Tenn. The third (optional) powering device 12 is a primary or disposable battery, such as a Lithium battery which is non-rechargeable. In addition, the powering devices (4, 10 and 12) may be an ink-based energy cell. Such printed power source is well known for its ultra-low profile design which is usually less than 1 millimeter in thickness, lightweight and flexible. An example of such low profile energy cell may be based on a standard zinc anode, manganese dioxide cathode structure, and an electrolyte printed onto a flexible paper or polymer substrate.

The selection of which powering devices (4, 10 and 12) to use may be performed by the integrated circuit (IC) 6. For example, the integrated circuit 6 is configured to select the source of electrical energy based on the “sleep” or “talk” modes of the RFID tag 2. In the “sleep” mode, the RFID tag 2 listens for an activation signal of a RFID reader. In the “talk” mode, the RFID tag 2 exchanges data with the RFID reader. The RFID tag 2 consumes more electrical energy in the “talk” mode than in the “listen” mode.

In another configuration, the RFID tag 2 may draw its electrical energy from the first powering device 4 when it is in the “sleep” mode. In addition, the RFID tag 2 uses the second powering device 10 when the integrated circuit 6 detects that the first powering device 4 is non-functioning. For example, when the RFID tag 2 is in darkness and light energy is unavailable to activate the solar cell layer (first powering device 4) then the second or third powering devices 10 and/or 12 may provide power to the IC 6. In the event that the energy from the second powering device 10 is depleted, the RFID tag 2 utilizes the third powering device 12.

Stated differently, the RFID tag 2 is powered by solar cell layer (first powering device 4) in the “sleep” mode. And when the RFID tag 2 is in storage where light is unavailable, the rechargeable battery (second powering device 10) supplies energy to the RFID tag 2. If the RFID tag 2 is in storage for an extended period of time, the primary battery (third powering device 12) replaces the rechargeable battery (second powering device 10) as the source of electrical energy. When sufficient light is available to activate the solar cell, then the solar cell may recharge the rechargeable battery.

When the RFID tag 2 is in the “talk mode”, the RFID tag 2 may utilize electrical energy from the second powering device 10 or/and third powering device 12.

It can be seen, from this description, that the use of electrical energy from the first, second or third powering devices (4, 10 and 12) is subject to different factors, such as requirements of the uses of IC 6 or conditions of the environment. In addition, the RFID tag 2 may be configured to utilize electrical energy from a single or multiple powering devices (4, 10 and 12) at any one time. In another embodiment, the third powering device 12 (primary battery) may not be required.

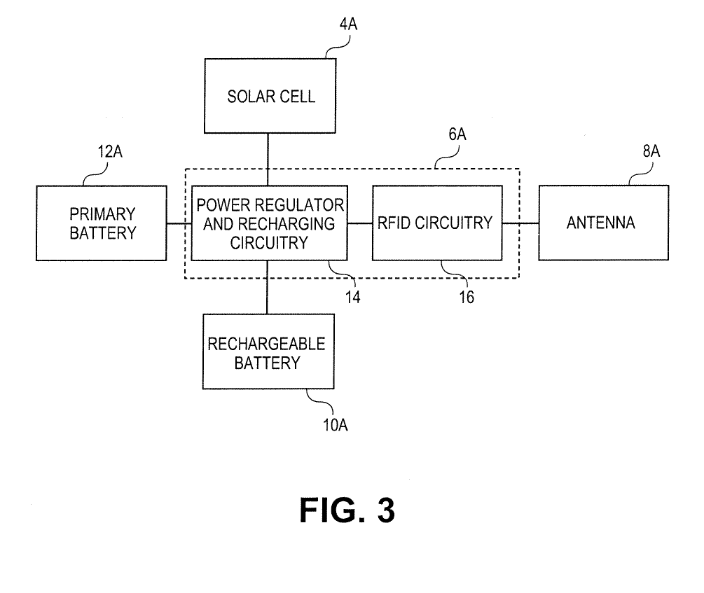

A further embodiment of the integrated circuit 6 is illustrated in FIG. 3. The integrated circuit 6A includes a power regulator circuitry and recharging circuitry 14 and a RFID circuitry 16. Existing technology relating to the power regulator circuitry and recharging circuitry 14 may be applied in combination with the present invention. In this example, the power regulator circuitry and recharging circuitry 14 is connected to the solar cell 4A, the rechargeable battery 10A and the primary battery 12A to measure their respective voltage supplies. Therefore, the integrated circuit 6A is able to select the power source for the RFID circuitry 16 and the antenna 8A and recharge the rechargeable battery 10A based on the respective voltage measurements. In one embodiment, recharging of the rechargeable battery may involve using, inductive coupling and capacitive coupling techniques. For example, inductive coupling can transfer energy from one circuit component, such as an inductor, to another circuit component when placed in close proximity by sharing a magnetic field. Similarly, capacitive coupling can transfer energy between two circuit components by mutual capacitance. In both of these cases, there is no physical connection between the two circuit components. That is, energy can be transferred from a device to the RFID tag and/or label without physical contact.

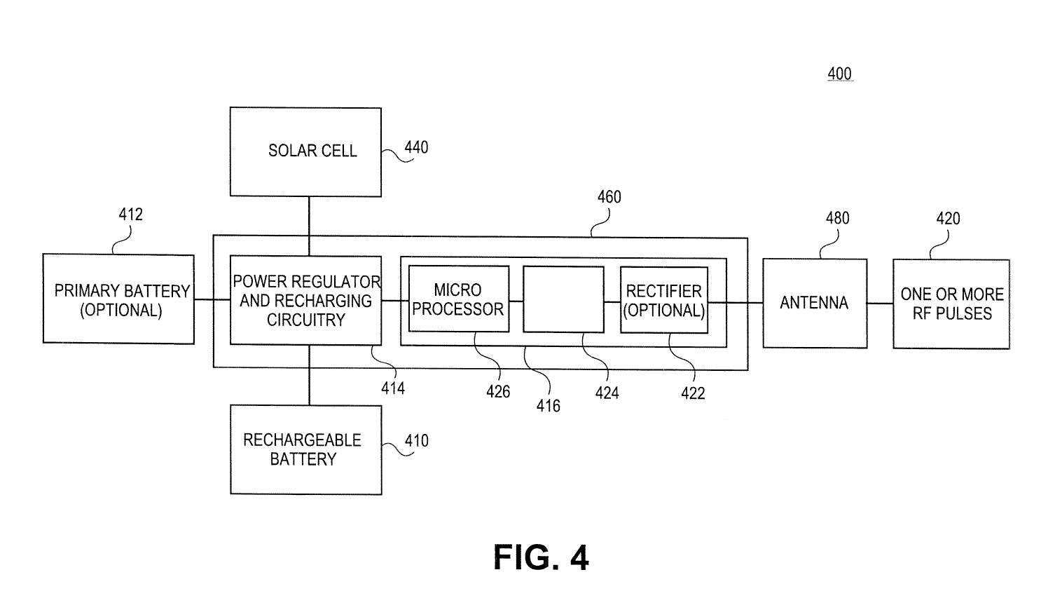

FIG. 4 shows one embodiment of a block diagram of a label that is configured to be activated and powered from an “off” mode using one or more RF pulses. A label 400 includes an integrated circuit (IC) 460, powering devices 440, 412, 410 coupled to IC 460, and an antenna 480 that is coupled to IC 460, as shown in FIG. 4. As shown in FIG. 4, one or more RF pulse 420 are received by antenna 480. IC 460 includes a power regulator and recharging circuitry 414 coupled to control power devices 440, 412, and 410. Power regulator and recharging circuitry 414 is coupled to microprocessor 426, e.g., a microcontroller, as shown in FIG. 4. In one embodiment, circuitry 414 is incorporated into a microprocessor chip 426. In another embodiment, circuitry 414 is on a chip that is separate from microprocessor chip 426. In one embodiment, label 400 is in the “off” mode until activated by a device. In one embodiment, the label 400 (e.g., RFID tag 2) is considered to be in the “off” mode when the integrated circuit 460 does not draw any electrical power from the powering devices 440, 412, and 4)0).

As shown in FIG. 4, one or more radio frequency signals 420 transmitted, e.g., from an object locating handheld device 3 depicted in FIG. 1, are received by antenna 480. In one embodiment, an activating RF signal received by antenna 480 activates the label 400. As shown in FIG. 4, the activating RF signal can be received and converted into a direct current signal by rectifier 422. As shown in FIG. 4, microprocessor can be activated using the direct current signal from rectifier 422. In one embodiment, rectifier 422 contains one or more semiconductor devices, such as Schottky diodes. The direct current signal from rectifier 422 activates a power activating semiconductor device 424, such as a CMOS gate. Further, power activating device 424 operates to activate microprocessor 426 in response to receiving of a rectified activating signal, e.g., a rectified RF pulse. In another embodiment, power activating device 424 includes a Micro-Electro-Machined (MEM) device. In yet another embodiment, power activating device 424 includes a switch. That is, power activating device 424 in turn activates power to microprocessor 426 in response to receiving the activating RF signal. The rectifier 422 may include one or more capacitors to store a charge created by rectifying the RF signal and this charge can be used to drive a gate of a FET (Field Effect Transistor) of other switching device in the device 424.

In one embodiment, power activating device 424 connects one or more powering devices 440, 412, and 410 to provide power to microprocessor 426, as shown in FIG. 4. In an alternative embodiment, rectifier 422 is not required, so that the radio frequency pulses activate the power activating semiconductor device 424 directly. In one embodiment power activating device 424 is incorporated into microprocessor 426 on a single chip. In another embodiment, power activating device 424 is placed on a chip that is different from microprocessor chip 426. As shown in FIG. 4, microprocessor 426 controls the power regulating and recharging circuit 414. In one embodiment, the activation of the microprocessor 426 puts label 400 in a “low power” mode. Label 400 in “low power” (“sleep”) mode consumes substantially less electrical power than in “full power” (“on” or “talk”) mode. In one embodiment, integrated circuit 460 includes a timer (not shown). The timer may be used to control the duration of a “sleep” mode.

Next, another one or more RF pulses are received by antenna 480. The another one or more RF pulses contain identifier information to locate an RFID label and/or tag. The microprocessor 426 checks the identification information being sought. For example, microprocessor 426 checks if the received identification information matches with the identification information that is stored in a memory (not shown) coupled to microprocessor 426. If the received identification information matches with the identification information stored in the memory, label 400 switches to a “full power” mode (turns on fully). Next, another RF signal having the identification information can be transmitted by integrated circuit 460 through antenna 480 to register the label 400. In one embodiment, if the identification information stored in the memory of the label 400 does not match with the received identification information, the microprocessor 426 returns to a “sleep” mode. In another embodiment, if the identification information stored in the memory of the label 400 does not match with the received identifier information, the microprocessor 426 returns to the “off” mode.

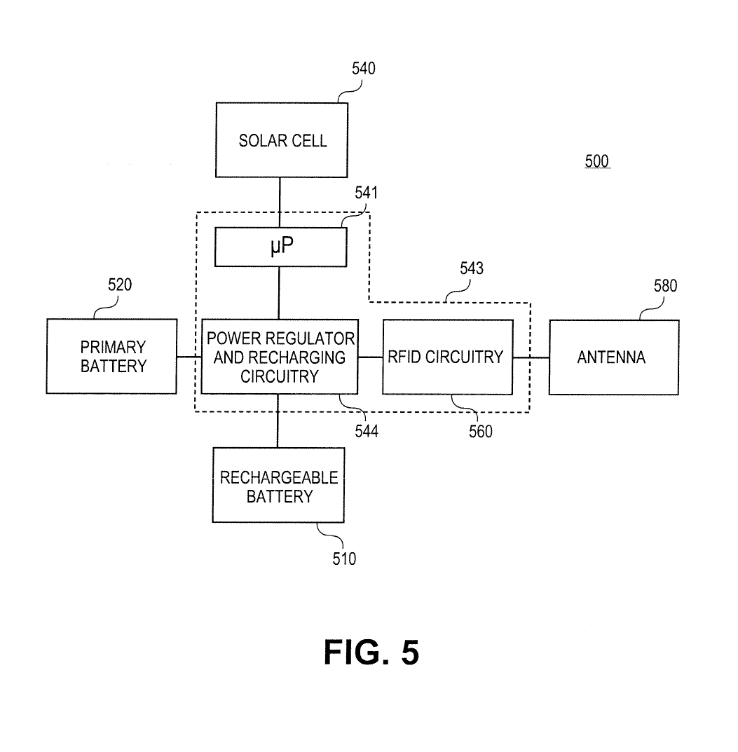

In an embodiment, a label (e.g., label 400 or label 500 depicted in FIG. 5 below) in an “off” state until activated by an object locating device, e.g., device 3 of FIG. 1. In one embodiment, when the label is manufactured it is coupled to a charged battery (i.e. a thin-film rechargeable battery.) The circuit is initially in an “off” mode rather than a “sleep” or “listen” mode. This off mode allows the label to have long shelf life. The user can turn the label on by activating the label with a device (i.e. a handheld device). The activation is accomplished by sending a radio frequency signal to the label. The antenna on the label will receive the signal from the device. This received signal will provide energy to activate the label.

Once activated, the label will exchange its unique code with the device. This “registration” of the label provides the device with a unique identifier for the label. The user can select a label to search from a list of stored unique identifiers in the device. When the user selects a unique identifier the devices transmits a signal with the code. The label transmits a response, which indicates a match, if transmitted data from the object locating device represents the information stored in the IC; a match response from the IC causes the object locating device to present a user interface, such as an audio sound and/or a displayed graphic which represents a received signal strength indication (RSSI), which indicates a location of the label (containing the IC) relative to the object locating device. The user interface may include an indication of range or distance to the object and an indication of the direction (e.g. in azimuth) of the object. If the transmitted data from the object locating device does not represent the information stored in the IC, then the IC does not transmit a response indicating a match.

FIG. 5 shows another embodiment of a block diagram of a label 500 that is activated and powered from an “off” mode using light. As shown in FIG. 5, label 500 includes an integrated circuit 543 coupled to antenna 580 and powering device 540 (e.g., a solar cell), powering device 520 (e.g., a primary battery), and 510 (e.g., a rechargeable battery). Integrated circuit includes a microprocessor 541 coupled between a solar cell powering device 540 and power regulator and recharging circuitry 544, as shown in FIG. 5. Integrated circuit 543 further includes an RFID circuitry 560 that can contain a label identifier information. RFID circuitry 560 is coupled to power regulator and recharging circuitry 544 and to antenna 580, as shown in FIG. 5.

Antenna 580 may be used to receive from and transmit RF signals to another device, e.g., an object locating handheld device. Initially, label 500 may be in an “off” mode without drawing any electrical power from any of powering devices 540, 520, and 510. Label 500 can turn itself on from an “off” state when exposed to light. In one embodiment, solar cell 540 is exposed to light, and converts the light signal into electrical signal. The electrical signal provided by solar cell 540 turns on microprocessor 541. In one embodiment, the electrical signal provided by solar cell 540 places microprocessor 541 into a “low power” mode from “off” mode. Next, one or more RF pulses may be received by antenna 580 after the microprocessor is turned on by light. The one or more RF pulses contain identifier information to locate an RFID label and/or tag.

The one or more RF pulses may be provided by the object locating device 3, e.g., an RFID reader, depicted in FIG. 1. The microprocessor 541 controls RFID circuitry 560 and power regulator and recharging circuitry 544, as shown in FIG. 5. In one embodiment, microprocessor 541 controls RFID circuitry 560 to check the identification information being sought. For example, microprocessor 541 may control RFID circuitry 560 to check if the received identification information matches with the identification information that is stored in a memory (not shown) coupled to microprocessor 541. If the identification information stored in the memory of the label 500 matches with the received identification information, the label 500 switches to a “full power” mode, e.g., turns on fully.

Next, an RF signal having an identification information can be transmitted by integrated circuit 543 through antenna 580 to register label 500. In one embodiment, if the identity of the label 500 does not match with the received identifier information, the microprocessor 541 returns to a “sleep” mode. In one embodiment, integrated circuit 543 includes a timer (not shown) to control the duration of a “sleep” mode. In another embodiment, if the identity of the label 500 does not match with the received identifier information, the microprocessor 541 returns to the “off” mode. 100511 In one embodiment, the object locating device, e.g., the RFID reader, can be a reader that can recognize all RFID tags. In one embodiment, a portion of the embedded code associated with the RFID tag includes a generic code. The object locating device, e.g., such as a “master” reader, can recognize the generic code and locate all tags and/ or all labels. One application of this embodiment is in emergency location applications, such as a lost hiker or skier. There are a multitude of applications of the RFID tag and reader detailed, including but not limited to incorporating the RFID reader into a personal device, such as a mobile phone. Other applications include installing the RFID tag on the windshield of an automobile, and using the RFID tag on hunting arrows.

The powering devices in the RFID tag and/or labels are controlled by the power regulating circuit which is controlled by a microprocessor. The power regulating circuit can control various modes of power consumption. These modes can be predetermined at the time of manufacture and programmed into the microprocessor in the RFID tag. In an alternative embodiment, a variety of modes can be stored in the microprocessor and the user would specify which mode to use. The encoded communication from the device, such as a handheld device, with the RFID tag would transfer the required information to specify mode of operation to the RFID tag.

Examples of power consumption modes include, but are not limited to powering the RFID tag from an “off” mode to “on” or “sleep” mode, returning the tag to “off” mode, and various timings associated with “on” and “sleep” modes. The “sleep” mode can include a timer that activates the device to “listen” for an incoming signal from a device at a predetermined amount of time.

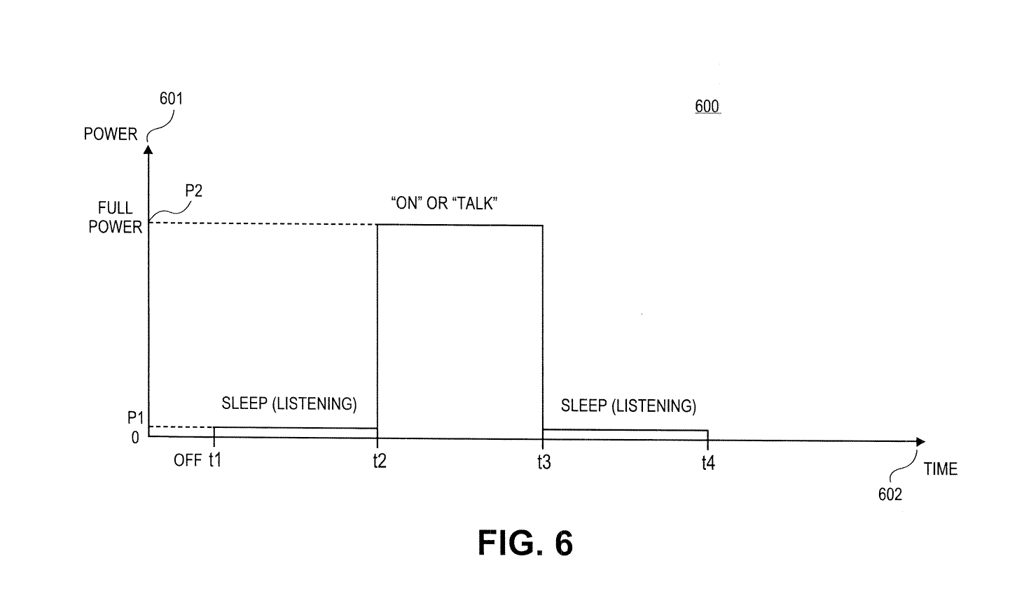

FIG. 6 shows one embodiment of a graph illustrating operating of a RFID label /and/or a RFID tag) in a plurality of modes of power consumption. Power consumption 601 is depicted against time 602, as shown in FIG. 6. Before time t1, the label, e.g., label 400, and/or label 500, is in an “off” mode, consuming zero electrical power from any of the one or more power devices described above with respect to FIGS. 1-5. At time t1, the label is placed into a “sleep” mode in response to receiving a power activating signal, as described above. In one embodiment, while in the “sleep” mode, the label listens to an object locating device, and consumes power P1.

In one embodiment, the label may receive one or more RF pulses from an object locating device that contain identification information while listening. The label may check if the identification information stored in a memory of the label matches to the identification information contained in the one or more RF pulses. If the identification information stored in the memory of the label matches to the identification information contained in the one or more RF pulses, the label is switched to “on” or “talk” mode. As shown in FIG. 6, while in the “talk” mode, the label consumes power P2, which may be substantially greater than power P1. In one embodiment, from time t2 to time t3 the label may be in a “full power” mode while talking to the object locating device. After talking, at time t3, the label may be switched back to the “sleep” mode. The “sleep” mode may be maintained until time t4. The duration of the “sleep” mode may be determined by a timer that may be contained in the integrated circuit of the label. At time t4 the label is switched back to the “off” mode that consumes no power.

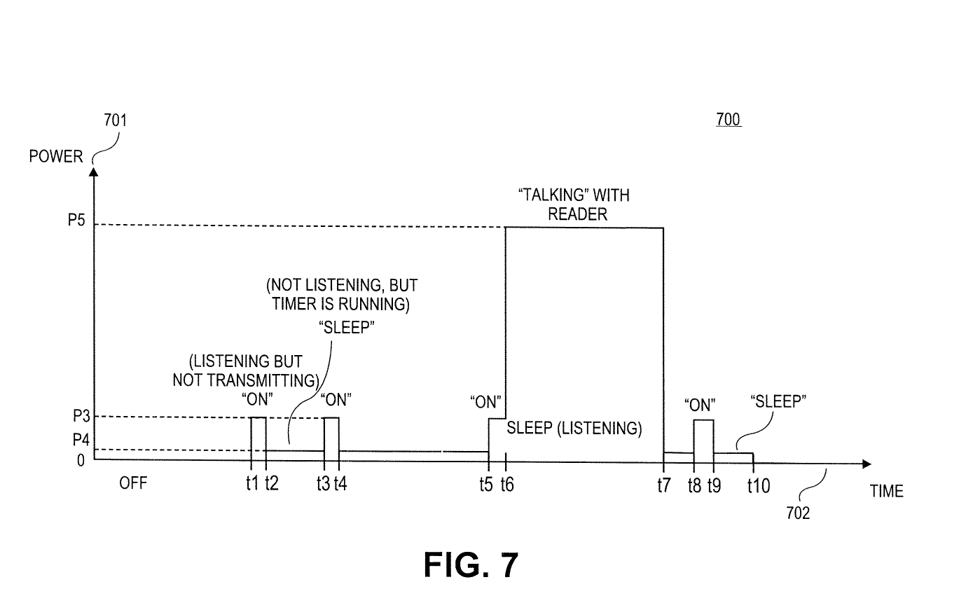

FIG. 7 shows another embodiment of a graph illustrating operating of a RFID label (and/or a RFID tag) in a plurality of modes of power consumption. Power consumption 701 is depicted against time 702, as shown in FIG. 7. Before time t1, the label, e.g., label 400, and/or label 500, is in an “off” mode, consuming zero electrical power from any of the one or more power devices described above with respect to FIGS. 1-5. At time t1, the label is placed into an “on” mode in response to receiving a power activating signal, as described above. In one embodiment, while in the “on” mode, the label listens to an object locating device, and consumes power P3. The duration of the “on” mode may be controlled by a timer included into the integrated circuit of the label. At time t2 the label is placed into a “sleep” mode. In one embodiment, during the “sleep” mode, the label consumes power P4 that is less than power P3. For example, during the “sleep” mode only the timer of the label is activated, so that the label consumes power P4. In one embodiment, the timer is programmed to turn the label from “sleep” to “on” from time to time to “listen” to the object locating device, as shown in FIG. 7.

While listening, the label may receive one or more RF pulses from an object locating device that contain identification information. The label may check if the identification information stored in a memory of the label matches to the identification information contained in the one or more RF pulses. If the identification information stored in the memory of the label matches to the identification information contained in the one or more RF pulses, the label is switched to “talk” mode. As shown in FIG. 6, while in the “talk” mode, the label consumes power P5, which may be substantially greater than power P3 and P4. In one embodiment, from time t6 to time t7 the label may be in a “full power” mode while talking to the object locating device. After talking, at time t7, the label may be switched back to the “sleep” mode. The “sleep” mode may be maintained until time t8. The duration of the “sleep” mode may be also determined by the timer that is contained in the integrated circuit of the label. Between time t8 and t9 the label is switched back to the “on” mode that consumes power P3, as shown in FIG. 7. At time t10, the label is switched back to the “off” mode that consumes no power, as shown in FIG. 7.

In one embodiment, if the identification the identification information of the label does not match to the identification information from the object locating device, the label turns to “sleep” mode, or “off” mode, as described above.

Thus, a method and a system for activating and powering RFID tags and/or labels have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to activate a label, comprising:
receiving a first radio frequency (RF) signal;
converting the RF signal into a direct current signal by a rectifier;
driving a gate of a power activating device directly with the direct current signal, wherein the power activating device is coupled to an integrated circuit (IC) of a label; and
activating the label from an “off” mode in response to driving the gate, wherein the label includes one or more powering devices coupled to the IC, wherein the one or more powering devices include a rechargeable battery and a solar power device, and wherein the IC is configured to draw no power from the one or more powering devices when the label is in the “off” mode.

2. The method of claim 1, further comprising:
providing a power from at least one of the one or more powering devices to the integrated circuit in response to the receiving.

3. (canceled)

4. (canceled)

5. The method of claim 1, wherein the activating the label from the “off” mode includes placing the integrated circuit into a “low power” mode.

6. The method of claim 1, further comprising:
receiving a second RF signal, wherein the second RF signal includes a first identifier information;
checking if the first identifier information matches a second identifier information stored in a memory; and
switching to a “full power” mode if the first identifier information matches the second identifier information.

7. The method of claim 6, further comprising:
returning to the “off” mode if the first identifier information does not match the second identifier information.

8. The method of claim 6, further comprising:
continuing the “low power” mode if the first identifier information does not match the second identifier information.

9. The method of claim 1, further comprising:
transmitting a third RF signal having a third identifier information to register the label.

10. A method to activate a label, comprising:
receiving a light signal;
converting the light signal into a direct current signal;
driving a gate of a power activating device directly with the direct current signal, wherein the power activating device is coupled to an integrated circuit (IC) of a label; and
activating the label from an “off” mode in response to driving the gate, wherein the label includes an integrated circuit (IC) and one or more powering devices coupled to the IC, wherein the one or more powering devices include a solar power device, and wherein the IC is configured to draw no power from the one or more powering devices when the label is in the “off” mode.

11. The method of claim 10, further comprising:
providing a power from at least one of the one or more powering devices to the integrated circuit in response to the receiving.

12. (canceled)

13. (canceled)

14. The method of claim 10, wherein the activating the label from the “off” mode includes placing the integrated circuit into a “low power” mode.

15. The method of claim 10, further comprising:
receiving a second light signal, wherein the second light signal includes a first identifier information;
checking if the first identifier information matches with a second identifier information stored in a memory; and
switching to a “full power” mode if the first identifier information matches the second identifier information.

16. The method of claim 15, further comprising:
returning to the “off” mode if the first identifier information does not match the second identifier information.

17. The method of claim 15, further comprising:
continuing to maintain the “low power” mode if the first identifier information does not match the second identifier information.

18. The method of claim 10, further comprising:
transmitting an RF signal having an identifier information to register the label.

19. An apparatus, comprising:
an integrated circuit (IC) containing an information relating to an object;
an antenna coupled to the IC to receive a first radio frequency (RF) signal
a rectifier to convert the RF signal into a direct current signal;
a power activating device coupled to the rectifier and to the IC, the power activating device comprising a gate that is directly driven by the direct current signal; and
one or more powering devices coupled to the IC to provide a power to activate the IC from an “off” mode when the gate is driven, wherein the IC is configured to draw no power from the one or more powering devices when the IC is in the “off” mode.

20. The apparatus of claim 19, wherein the IC comprises
a microprocessor, and
a power regulating and recharging circuitry coupled to the microprocessor, wherein the microprocessor is configured to control the power regulating and recharging circuitry.

21. (canceled)

22. The apparatus of claim 19 wherein the one or more powering devices include a solar cell, a rechargeable battery, or any combination thereof.

23. The apparatus of claim 19, wherein the integrated circuit includes an RFID code stored in a memory.

24. The apparatus of claim 19, wherein the integrated circuit includes a timer.

25. A non-transitory machine-readable medium providing executable program instructions which cause the processing system in a label to perform operations, comprising:
receiving a first radio frequency (RF) signal;
converting the RF signal into a direct current signal by a rectifier;
driving a gate of a power activating device directly with the direct current signal, wherein the power activating device is coupled to an integrated circuit (IC) of a label; and
activating the label from an “off” mode in response to the driving, wherein the label includes one or more powering devices coupled to the IC, wherein the one or more powering devices include a rechargeable battery and a solar power device, and wherein the IC is configured to draw no power from the one or more powering devices when the label is in the “off” mode.

26. The non-transitory machine-readable medium of claim 25, further including data that cause the processing system in the label to perform operations, comprising:
providing a power from at least one of the one or more powering devices to the integrated circuit in response to the receiving.

27. (canceled)

28. The non-transitory machine-readable medium of claim 25, further including data that cause the processing system in the label to perform operations, comprising:
receiving a second RF signal, wherein the second RF signal includes a first identifier information;
checking if the first identifier information matches a second identifier information stored in a memory; and
switching to a “full power” mode if the first identifier information matches the second identifier information.

29. The non-transitory machine-readable medium of claim 25, further including data that cause the processing system in the label to perform operations, comprising:
returning to the “off” mode if the first identifier information does not match the second identifier information.

30. The non-transitory machine-readable medium of claim 25, further including data that cause the processing system in the label to perform operations, comprising:
continuing the “low power” mode if the first identifier information does not match the second identifier information.

31. The non-transitory machine-readable medium of claim 25, further including data that cause the processing system in the label to perform operations, comprising:
transmitting a third RF signal having a third identifier information to register the label.

32. A non-transitory machine-readable medium providing executable program instructions which cause the processing system in a label to perform operations, comprising:
receiving a light signal;
converting the light signal into a direct current signal;
driving a gate of a power activating device directly with the direct current signal, wherein the power activating device is coupled to an integrated circuit (IC) of a label; and
activating the label from an “off” mode in response to driving the gate, wherein the label includes an integrated circuit (IC) and one or more powering devices coupled to the IC wherein the one or more powering devices include a solar power device, and wherein the IC is configured to draw no power from the one or more powering devices when the label is in the “off” mode.

33. The non-transitory machine-readable medium of claim 32, further including data that cause the processing system in the label to perform operations, comprising:
receiving a second light signal, wherein the second light signal includes a first identifier information;
checking if the first identifier information matches a second identifier information stored in a memory; and
switching to a “full power” mode if the first identifier information matches the second identifier information.

34. The non-transitory machine-readable medium of claim 32, further including data that cause the processing system in the label to perform operations, comprising:
returning to the “off” mode if the first identifier information does not match the second identifier information.

35. The non-transitory machine-readable medium of claim 32, further including data that cause the processing system in the label to perform operations, comprising:
continuing to maintain the “low power” mode if the first identifier information does not match the second identifier information.

36. The non-transitory machine-readable medium of claim 32, further including data that cause the processing system in the label to perform operations, comprising:
transmitting a RF signal having an identifier information to register the label.

37. A label to be attached to an object to be located, the label comprising:
an integrated circuit (IC) containing an information relating to the object;
an antenna coupled to the IC, the antenna for communicating the information with an object locating device and for receiving a radio frequency (RF) activation signal;
a rectifier to convert the RF activation signal into a direct current signal;
a power activating device coupled to the rectifier and to the IC, the power activating device comprising a gate that is directly driven by the direct current signal; and
one or more powering devices coupled to activate the IC from an “off” mode when the gate is driven in response to receiving the RF activation signal from the object locating device, wherein the one or more powering devices include a rechargeable battery and a solar power device which is configured to recharge the rechargeable battery, and wherein the IC is configured to draw no power from the one or more powering devices when the label is in the “off” mode.

38. The label of claim 37, wherein the label has the thickness less than 2.0 mm and wherein the rechargeable battery is a printed rechargeable battery and wherein the label has an adhesive layer to allow the label to be attached to the object, and wherein the information is programmable in the IC through a programming operation by the object locating device which is portable.

39. The label of claim 37, wherein the IC comprises an RFID circuitry and a power regulating circuitry for controlling charging of the rechargeable battery by the solar power device that is disposed in a flexible substrate and wherein the object locating device comprises an RFID reader which transmits first data representing the information.

40. The label of claim 39, wherein the RFID reader transmits only one identifier at a time in order to locate only one object having one identifier.

41. The label of claim 40, wherein the one or more powering devices comprise a non-rechargeable battery coupled to the IC wherein the non-rechargeable battery provides power to the IC while the solar power device recharges the rechargeable battery.

42. The label of claim 39, wherein the label transmits a response indicating a match if first data from the object locating device represents the information and wherein the match causes the object locating device to present a user interface which indicates a location of the label relative to the object locating device and wherein the label does not transmit a response indicating a match if the first data does not represent the information.

43. The label of claim 42, wherein the label is configured to be attached to a golf club and wherein the object locating device alerts a user if the golf club is beyond a distance and wherein the object locating device sequentially transmits a series of codes one at a time, each corresponding to one golf club.

44. A label to be attached to an object to be located, the label comprising:
an integrated circuit (IC) containing an information relating to the object;
an antenna coupled to the IC, the antenna for communicating the information with an object locating device and for receiving a radio frequency (RF) activation signal;
a rectifier to convert the RF activation signal into a direct current signal;
a power activating device coupled to the rectifier and to the IC, the power activating device comprising a gate that is directly driven by the direct current signal; and
a plurality of powering devices coupled to the IC to provide electrical energy to the IC when the label is activated from an “off” mode when the gate is driven, wherein the IC is capable of selecting at least one of the plurality of the powering devices, wherein the plurality of powering devices includes a rechargeable battery and a solar power device which is configured to recharge the rechargeable battery, and wherein the IC is configured to draw no power from the one or more powering devices when the label is in the “off” mode.

45. The label as in claim 44 wherein the label is less than about 2.0 mm in thickness and wherein the rechargeable battery is a printed rechargeable battery and wherein the label has an adhesive layer to allow the label to be attached to the object and wherein the information is programmable in the IC through a programming operation by the object locating device which is portable.

46. The label as in claim 44 wherein the IC comprises RFID circuitry and power regulating circuitry for controlling charging of the rechargeable battery by the solar power device and wherein the solar power device is disposed in a flexible substrate and wherein the object locating device comprises an RFID reader which transmits first data representing the information.

47. The label as in claim 46 wherein the RFID reader transmits only one identifier at a time in order to locate only one object having the one identifier.

48. The label as in claim 47 wherein the plurality of powering devices comprises a non-rechargeable battery coupled to the IC wherein the non-rechargeable battery provides power to the IC while the solar power device recharges the rechargeable battery.

49. The label as in claim 45 wherein the label transmits a response indicating a match if first data from the object locating device represents the information and wherein the match causes the object locating device to present a user interface which indicates a location of the label relative to the object locating device and wherein the label does not transmit a response indicating a match if the first data does not represent the information.

50. The label as in claim 49 wherein the label is configured to be attached to a golf club and wherein the object locating device alerts a user if the golf club is beyond a distance and wherein the object locating device sequentially transmits a series of codes one at a time, each corresponding to one golf club.
